(19) United States
(12) Patent Application Publication
(10) Pub. No.: US 2023/0016133 A1
(43) Pub. Date: Jan. 19, 2023

(54) OPTICAL FIBER

(71) Applicant: SUMITOMO ELECTRIC INDUSTRIES, LTD., Osaka-shi, Osaka (JP)

(72) Inventors: Takemi HASEGAWA, Osaka-shi, Osaka (JP); Yuki KAWAGUCHI, Osaka-shi, Osaka (JP)

(73) Assignee: SUMITOMO ELECTRIC INDUSTRIES, LTD., Osaka-shi, Osaka (JP)

(21) Appl. No.: 17/782,390

(22) PCT Filed: Dec. 10, 2020
(86) PCT No.: PCT/JP2020/046101

§ 371 Date: Jun. 3, 2022

(30) Foreign Application Priority Data
Dec. 13, 2019 (JP) 2019-225471

(51) Int. Cl. G02B 6/02

(52) U.S. Cl. CPC G02B 6/02395

(57) ABSTRACT

The present disclosure relates to an optical fiber having a structure that has a low transmission loss and can be produced with high productivity. An optical fiber according to an embodiment includes a core and a cladding. The core is comprised of silica glass to which bromine is added, and the cladding has a refractive index lower than a maximum refractive index of the core. The core has compressive stress.

### TECHNICAL FIELD

The present disclosure relates to an optical fiber.

This application claims the priority of Japanese Patent Application No. 2019-225471 filed on Dec. 13, 2019, which is relied upon and incorporated herein by reference in its entirety.

### BACKGROUND ART

Demand for a transmission capacity continues to increase, and optical fiber cables are laid to meet this demand. At this time, it is possible to improve ae signal-to-noise ratio and reduce the number of optical amplifiers by laying an optical fiber having a lower transmission loss, and there is an effect of improving cost effectiveness of a system particularly in long-distance transmission. Thus, a pure silica core fiber (PSCF) having a low transmission loss is increasingly used in long-distance transmission instead of a standard single mode fiber (SSMF) having a GeO₂-added core.

The PSCF has a core comprised of silica glass not containing GeO₂ and a cladding comprised of silica glass of which a refractive index is reduced by adding fluorine (F). The addition of F to silica glass is realized by heating and sintering a soot body of silica glass in an atmosphere of a fluorine-containing gas such as SiF₄ or CF₄, but a process of adding F is generally lower in productivity and higher in cost than a process of manufacturing pure silica glass. This tendency becomes more remarkable as an F concentration increases. In the PSCF and the SSMF, an outer diameter of the cladding is 125 μm, whereas an outer diameter of the core is only about 10 μm. Thus, the low productivity of the cladding occupying 99% or more of a volume greatly affects the productivity of the entire optical fiber. As a result, the PSCF is more expensive than the SSMF, and currently, the production amount in the entire industry is only about 1/100 of the SSMF.

On the other hand, the SSMF has a cladding comprised of pure silica glass or silica glass containing a very small amount of F, and a core comprised of silica glass of which a refractive index is increased by adding GeO₂. Since the productivity of the cladding is high, the productivity is higher than the productivity of the PSCF, but the transmission loss increases by adding GeO₂ to the core. When the transmission loss at a wavelength of 1550 nm is compared, the PSCF has a transmission loss of 0.15 dB/km or more and 0.17 dB/km or less, whereas the SSMF has a high transmission loss of 0.18 dB/km or more and 0.20 dB/km or less.

Thus, as one of fiber structures that achieve both low transmission loss and high productivity, an optical fiber in which a refractive index is increased by adding high-concentration chlorine (Cl) instead of GeO₂ to a core and a method for manufacturing the optical fiber are proposed in Patent Document 1 below. However, in order to add Cl having a concentration sufficient to guide light, it is necessary to sinter a soot body of silica glass in an atmosphere containing SiCl₄ gas several times an atmospheric pressure. There is a high possibility that bubbles are generated in glass due to vaporization of SiCl₄ even in a post-process after sintering.

As another fiber structure that achieves both low transmission loss and high productivity, an optical fiber in which a refractive index is increased by adding bromine (Br) instead of GeO₂ to a core and a method for manufacturing the optical fiber are proposed in Patent Document 2 below. It is possible to add Br having a concentration sufficient to guide light by sintering a soot body of silica glass in an atmosphere containing SiBr₄ substantially equal to an atmospheric pressure. SiBr₄ has a feature of having a molecular weight larger than a molecular weight of SiCl₄, and SiBr₄ is less likely to vaporize.

### CITATION LIST

### Patent Literature

Patent Document 1: US 2019/0119143 A1
Patent Document 2: US 2017/0176673 A1

### SUMMARY OF INVENTION

An optical fiber according to an embodiment of the present disclosure includes a core that extends along a central axis and a cladding that surrounds the core. The core is comprised of silica glass to which bromine is added. The cladding has a refractive index lower than a maximum refractive index of the core, and is comprised of silica glass. The remaining stress of the core is compressive stress.

### BRIEF DESCRIPTION OF DRAWINGS

FIG. 1 is a diagram illustrating a schematic structure of a manufacturing apparatus for manufacturing an optical fiber according to each embodiment of the present disclosure.

FIG. 2 is a diagram illustrating a cross-sectional structure of each of optical fibers (type A to type C) according to first to third embodiments of the present disclosure.

FIG. 3 illustrates a refractive index profile, a viscosity distribution, and a stress distribution of the optical fiber (type A) according to the first embodiment of the present disclosure along a common straight line orthogonal to a central axis of the optical fiber.

FIG. 4 is an enlarged view of a region R1 in the refractive index profile and the viscosity distribution illustrated in FIG. 3.

FIG. 5 illustrates a refractive index profile, a viscosity distribution, and a stress distribution of the optical fiber (type B) according to the second embodiment of the present disclosure along the common straight line orthogonal to the central axis of the optical fiber.

FIG. 6 illustrates a refractive index profile, a viscosity distribution, and a stress distribution of the optical fiber (type C) according to the third embodiment of the present disclosure along the common straight line orthogonal to the central axis of the optical fiber.

FIG. 7 is a diagram illustrating a cross-sectional structure of an optical fiber according to a fourth embodiment (type D) of the present disclosure.

FIG. 8 illustrates a refractive index profile, a viscosity distribution, and a stress distribution of the optical fiber according to the fourth embodiment (type D) of the present disclosure along a common straight line orthogonal to a central axis of the optical fiber.

### DESCRIPTION OF EMBODIMENTS

### Problem to be Solved by Present Disclosure

The inventors have found the following problems as a result of examining the above-mentioned related art. That is, a fiber in which Br is added to a core tends to have a high transmission loss, and Patent Document 2 reports a transmission loss higher than GeO₂. Accordingly, there is a problem in the related art to reduce the transmission loss in the fiber in which Br is added to the core.

The present disclosure has been made to solve the above-described problems, and an object of the present disclosure is to provide an optical fiber having a structure that has a low transmission loss and can be produced with high productivity.

### Advantageous Effects of Invention

According to the present disclosure, it is possible to reduce a transmission loss and realize high productivity by providing an optical fiber including a core to which Br is added and having compressive stress.

### Details of Embodiment of Present Application

Hereinafter, contents of embodiments of the present disclosure will be individually listed and described.

First, terms common to the embodiments of the present disclosure will be described, and further, the contents of the embodiments of the present disclosure will be individually listed and described.

### DEFINITION OF TERMS

In the present specification, it is assumed that a relative refractive index difference Δ of a certain medium (refractive index n) with pure silica glass (refractive index n0) as a reference is given as follows.

Δ=(n/n0)−1

Unless otherwise specified, it is assumed that an “optical fiber” has one central axis, is substantially rotationally symmetric about the central axis, and is translationally symmetric along the central axis. With respect to components of the optical fiber such as a core, a cladding, and a coating, unless otherwise specified, it is assumed that the components are substantially rotationally symmetric about the central axis and translationally symmetric along the central axis. When these assumptions are applicable, physical property values of the components of the optical fiber are defined in any cross section orthogonal to the central axis. When statistical values such as an average value, a maximum value, and a percentile value of the physical property values are defined, the physical property values in the cross section described above are replaced with the statistical values for a set of measured values obtained by measuring at a spatially uniform frequency with a predetermined spatial resolution. Unless otherwise stated, the spatial resolution described above assumes a circle with a radius of 1 μm, which is an approximation of an operating wavelength of the optical fiber.

In an outer region of the core surrounding an inner region near the central axis, a refractive index profile of the core has a shape satisfying a relationship in which a relative refractive index difference Δ0 at a portion separated from the central axis by a distance r0 along a radial direction, a relative refractive index difference Δ1 at a portion separated from the central axis by a distance r1 longer than the distance r0, and a relative refractive index difference Δr at a portion separated from the central axis by a distance r equal to or longer than the distance r0 and equal to or shorter than the distance r1 are approximated by the following Equation (1):

Δr=Δ0+(A1−A0)×((r−r0)/(r1−r0))α (1).

The shape is adjusted by changing a value of the exponent α (for example, α=2.0). Since it is difficult to accurately control the refractive index profile in the inner region including the central axis and near the central axis in a manufacturing process of the optical fiber, the refractive index profile is accurately controlled in the outer region of the core surrounding the inner region.

(1) As one aspect, an optical fiber according to an embodiment of the present disclosure includes a core that extends along a central axis and a cladding that surrounds the core. The core is comprised of silica glass to which bromine is added. The cladding has a refractive index lower than a maximum refractive index of the core, and is comprised of silica glass. The remaining stress of the core is compressive stress. With such a configuration, it is possible to achieve both a low transmission loss and high productivity.

(2) As one aspect of the present disclosure, the cladding may have a multilayer structure. As an example, the cladding includes a first cladding that surrounds the core in a state of coining into contact with an outer peripheral surface of the core, and a second cladding that surrounds the first cladding in a state of coining into contact with an outer peripheral surface of the first cladding. The first cladding is comprised of silica glass to which fluorine is added. The second cladding is comprised of pure silica glass or silica glass to which fluorine having a concentration lower than a fluorine concentration of the first cladding is added. The second cladding has tensile stress. Such a configuration can realize a lower transmission loss and can achieve both the low transmission loss and high productivity. In particular, the second cladding is preferably pure silica glass in which a concentration of a halogen element is suppressed to less than 0.1 wt %. As a result, a large viscosity difference of the second cladding with respect to the core is realized. Thus, tensile stress is formed in the second cladding and compressive stress is formed in the core.

(3) As one aspect of the present disclosure, a multilayer structure of the cladding may include a first cladding that surrounds the core in a state of coining into contact with an outer peripheral surface of a core, a second cladding that surrounds the first cladding in a state of coming into contact with an outer peripheral surface of the first cladding, and a third cladding that surrounds the second cladding in a state of coming into contact with an outer peripheral surface of the second cladding. The first cladding is comprised of silica glass to which fluorine is added. The second cladding is comprised of pure silica glass or silica glass to which fluorine having a concentration lower than a fluorine concentration of the first cladding is added. With this configuration, the remaining stress of the second cladding is tensile stress. The third cladding is comprised of pure silica glass or silica glass to which fluorine having a concentration lower than a fluorine concentration of the first cladding is added. With this configuration, the remaining stress of the third cladding is compressive stress. Even with such a configuration, a lower transmission loss can be realized, and both the low transmission loss and high productivity can be achieved.

(4) As one aspect of the present disclosure, preferably, the core further contains chlorine, and the optical fiber has a viscosity adjustment region. The viscosity adjustment region is a region defined on a cross section of the optical fiber orthogonal to the central axis, and includes a part of the core and a part of the cladding adjacent to each other across a boundary between the core and the cladding (the first cladding when the cladding has a multilayer structure). Specifically, the viscosity adjustment region has a shape surrounding the central axis in a state of being separated from the central axis, and the shape of the viscosity adjustment region (planar shape defined on the cross section) has an inner peripheral portion and an outer peripheral portion arranged to sandwich a boundary between the core and the cladding in a state of being separated by a distance (corresponding to a width of the viscosity adjustment region defined along a radial direction) of 2 μm or more. In the viscosity adjustment region having such a shape, a viscosity distribution (distribution defined along the radial direction) of the optical fiber has a viscosity distribution that continuously changes along the radial direction. The radial direction coincides with a direction from the central axis toward an outer periphery of the optical fiber on the cross section of the optical fiber.

As described above, each of the aspects listed in the [Description of Embodiments of the Present Disclosure] is applicable to each of all the remaining aspects or all combinations of these remaining aspects.

### Details of Embodiments of Present Disclosure

Hereinafter, a specific structure of an optical fiber according to an embodiment of the present disclosure will be described in detail with reference to the accompanying drawings. The present invention is not limited to these examples, but is defined by the scope of the claims. The present invention is intended to include meanings equivalent to the claims and all modifications within the claims. In the description of the drawings, the same components are denoted by the same reference signs, and the redundant description will be omitted.

(Optical Fiber Manufacturing Apparatus)

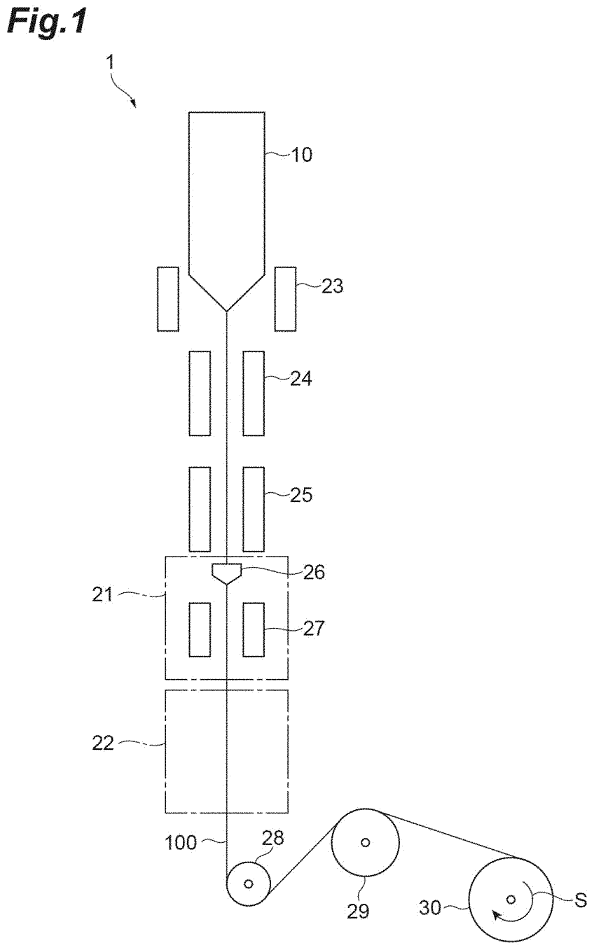

FIG. 1 is a diagram illustrating a schematic structure of a manufacturing apparatus for manufacturing an optical fiber according to each embodiment of the present disclosure. An optical fiber manufacturing apparatus 1 illustrated in FIG. 1 includes a drawing furnace 23 that heats one end of an optical fiber preform 10, a heating furnace 24 of which a temperature is controlled, a cooling device 25 that cools a bare fiber drawn in a He atmosphere, a die 26 for applying a coating resin on an outer peripheral surface of the cooled bare fiber, an ultraviolet light source 27 that outputs ultraviolet light for curing the resin, a roller 28, a capstan 29, and a winder 30. The die 26 and the ultraviolet light source 27 constitute a resin coating device 21, and a primary coating is provided on the outer peripheral surface of the bare fiber by the resin coating device 21. On a downstream side of the resin coating device 21, a resin coating device 22 (including a die and an ultraviolet light source) having a structure similar to the structure of the resin coating device 21 positioned on an upstream side is disposed, and a secondary coating is provided on an outer peripheral surface of the primary coating provided by the resin coating device 21 on the upstream side.

Specifically, one end of the prepared optical fiber preform 10 is heated by the drawing furnace 23, and the bare fiber is spun from the heated end. A temperature of the bare fiber coining out of the drawing furnace 23 is gradually lowered in the heating furnace 24 of which a temperature is controlled. During this time, structural relaxation of glass occurs in the bare fiber, and this structural relaxation eliminates an increase in transmission loss caused in the related art. The bare fiber coining out of the heating furnace 24 passes through the die 26 after being cooled in the He atmosphere of the cooling device 25. When the bare fiber passes through the die 26, a coating resin (primary coating) is applied onto the outer peripheral surface of the bare fiber. The applied coating resin is cured by being irradiated with ultraviolet light by the ultraviolet light source 27. An optical fiber 100 is obtained by providing the secondary coating by the resin coating device 22 on the primary coating provided by the resin coating device 21.

The roller 28 has a rotating surface inclined with respect to a traveling direction of the optical fiber 100 obtained by passing through the resin coating device 21 and the resin coating device 22. As a result, torsion is given to the optical fiber 100, and polarization mode dispersion can be reduced. The capstan 29 is positioned on a downstream side of the roller 28 and gives a predetermined tension to the optical fiber 100. As a result, compressive stress and tensile stress remain in a core and a cladding of the optical fiber 100 after drawing. The optical fiber 100 that has passed through the capstan 29 is wound up by the winder 30 that rotates in a direction indicated by an arrow S in the drawing.

In the example of FIG. 1, the resin coating device 21 that provides the primary coating and the resin coating device 22 that provides the secondary coating are arranged in order along the fiber traveling direction, but the secondary coating may be provided after the optical fiber provided with the primary coating is wound by the winder 30. In this case, the resin coating device 22 is unnecessary. That is, when the optical fiber provided with the primary coating is rewound from the winder 30 to another winding device, the secondary coating is provided on the rewound optical fiber.

A cross-sectional structure of the optical fiber 100 obtained by the optical fiber manufacturing apparatus 1 having the above-described structure is similar to a cross-sectional structure of the optical fiber preform 10. Thus, optical fibers having various cross-sectional structures such as an optical fiber 100a according to the first embodiment, an optical fiber 100b according to a second embodiment, and an optical fiber 100c according to a third embodiment to be described below are obtained by setting an optical fiber preform 10 having a different cross-sectional structure in the optical fiber manufacturing apparatus 1.

### First Embodiment

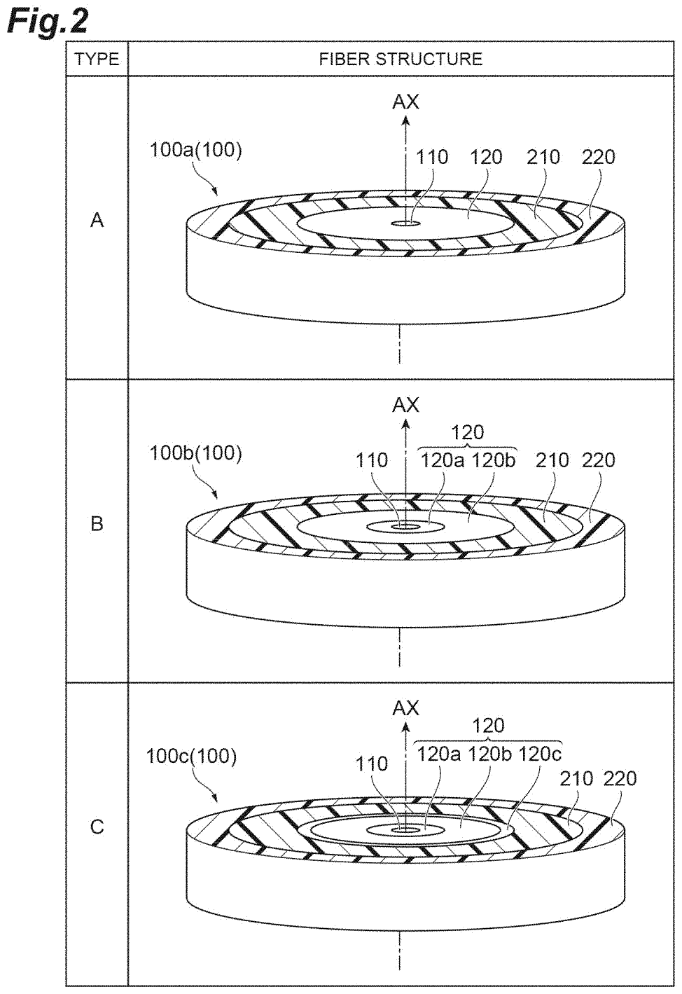

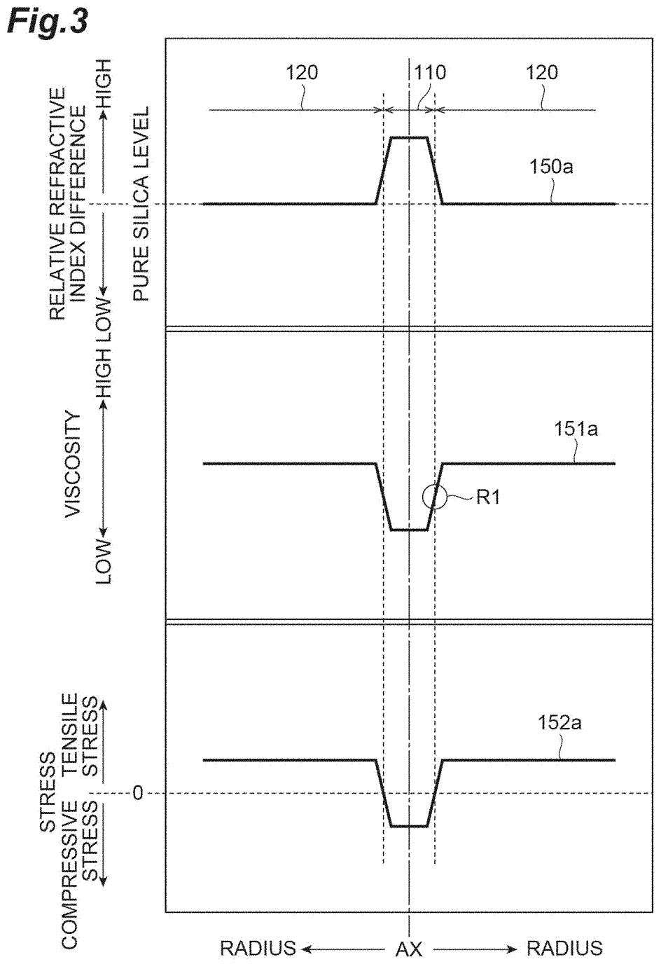

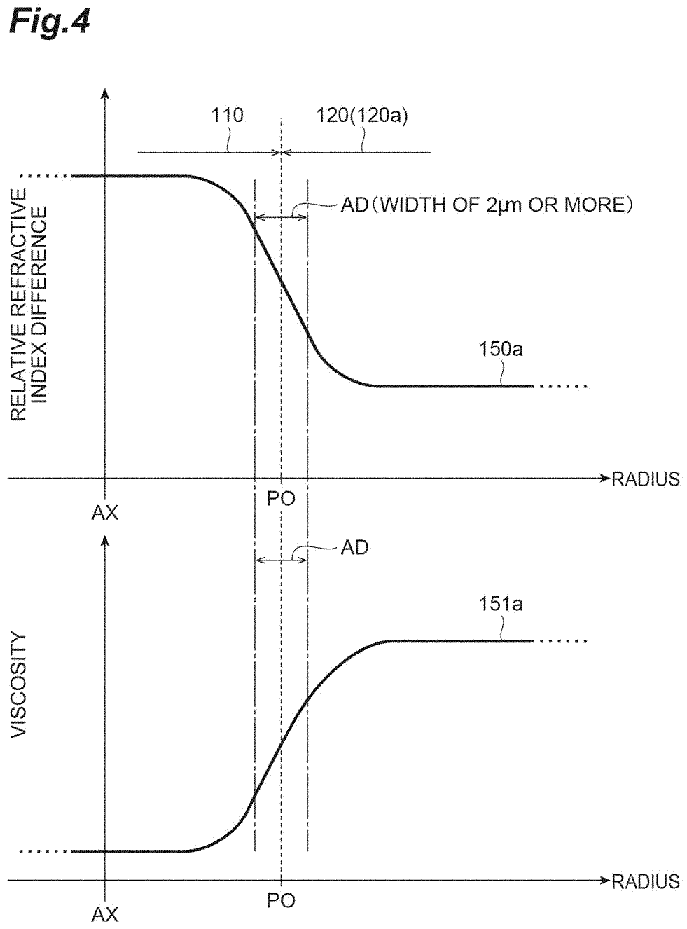

A type-A optical fiber illustrated in an upper part of FIG. 2 is the optical fiber 100a according to the first embodiment of the present disclosure. FIG. 3 illustrates a refractive index profile 150a, a viscosity distribution 151a, and a stress distribution 152a indicated along a common straight line orthogonal to a central axis AX of the optical fiber 100a. FIG. 4 is an enlarged view of a region R1 in the refractive index profile 150a and the viscosity distribution 151a illustrated in FIG. 3.

As illustrated in the upper part of FIG. 2, the type-A optical fiber 100a according to the first embodiment includes a core 110 extending along the central axis AX of the optical fiber 100a, a cladding 120 surrounding the core 110, a primary coating 210 surrounding the cladding, and a secondary coating 220 surrounding the primary coating 210.

The core 110 is comprised of silica glass (SiO2) containing bromine (Br). In the core 110, a Br concentration is 0.8 wt % or more and 2.6 wt % or less, preferably 1.6 wt % or more and 2.6 wt % or less. A maximum relative refractive index difference of the core 110 is 0.1% or more and 0.3% or less, preferably 0.2% or more and 0.3% or less. The cladding 120 is comprised of pure silica glass or silica glass containing a trace amount of fluorine (F) of 3000 ppm or less. More preferably, the cladding is comprised of silica glass in which a total concentration of chlorine, fluorine, and other halogen elements is suppressed to 0.1 wt % or less. FIG. 3 illustrates a simplified refractive index profile 150a of the optical fiber 100a according to the first embodiment. Here, a profile shape in an outer region of the core 110 is given by the above Equation (1), but in the refractive index profile 150a, the profile shape of the core 110 is shown as a schematic shape.

In the first embodiment, a diameter of the core 110 is 6 μm or more and 10 μm or less. With this configuration, the optical fiber 100a according to the first embodiment has one or more guided modes in a 1550-nm wavelength band that is a lowest loss wavelength band of silica glass (a set of two polarization modes is defined as one guided mode). An effective area of a fundamental mode at a wavelength of 1550 nm is preferably 60 μm2 or more and 120 μm2 or less. An outer diameter of the cladding 120 is preferably 125±1 μm. An outer diameter of the entire coating including the primary coating 210 and the secondary coating 220 (substantially an outer diameter of the secondary coating 220) is 245±5 μm, more preferably 200±5 μm.

Subsequently, a median value of the viscosity of the core 110 becomes lower than a maximum value of the viscosity of the cladding 120 due to a concentration difference between the additives described above. More preferably, the median value of the viscosity of the core 110 is lower than a 75% percentile value of the viscosity in the cladding 120. Even more preferably, the median value of the viscosity of the core is lower than a median value of the viscosity of the cladding 120. Due to such a viscosity difference between the portions, tension at the time of manufacturing the optical fiber 100a, particularly at the time of drawing the preform is supported by the cladding 120, and as a result, tensile stress remains in the cladding 120 of the optical fiber 100a after drawing, and compressive stress remains in the core 110. FIG. 3 illustrates a simplified viscosity distribution 151a and a simplified stress distribution 152a of the optical fiber 100a according to the first embodiment in addition to the refractive index profile 150a. Horizontal axes of the refractive index profile 150a, the viscosity distribution 151a, and the stress distribution 152a illustrated in FIG. 3 are illustrated such that positions on a cross section orthogonal to the central axis AX of the optical fiber 100a (positions on a straight line passing through the central axis AX) coincide with each other.

The compressive stress itself depends not only on the viscosity difference between the portions but also on drawing conditions such as tension at the time of drawing the preform. However, in order to suppress an increase in transmission loss, an absolute value of the compressive stress of the core 110 (an absolute value of an average value of stresses remaining in the core 110) is preferably 15 MPa or more, and more preferably 30 MPa or more. Even more preferably, the absolute value of the compressive stress of the core 110 is an absolute value of a 75% percentile value of the stress remaining in the core 110, and is preferably 30 MPa or more. When the tensile stress remains in the glass, an increase in transmission loss due to glass defects is likely to occur. However, when the remaining stress of the core 110 is compressive stress in which an absolute value of an average value or an absolute value of the 75% percentile value is sufficiently large as described above, an increase in transmission loss due to local tensile stress is effectively suppressed. It is assumed that the remaining stress is defined by a ratio when the tensile stress is expressed by a positive sign value and the compressive stress is expressed by a negative sign value and the percentile value is expressed by a ratio when values having signs are arranged in ascending order.

In the optical fiber 100a according to the first embodiment, the viscosity is different between the core 110 and the cladding 120, but a spatial change is preferably continuous and gentle. When the viscosity difference is steep between the core 110 and the cladding 120, a large variation in structure and remaining stress occurs at a boundary between the core 110 and the cladding 120 due to an unintended variation in temperature and tension during drawing. This may cause an increase in transmission loss. Accordingly, a spatial change in viscosity is gentle at the boundary between the core 110 and the cladding 120, and thus, an increase in transmission loss is suppressed. More preferably, as illustrated in FIG. 4, it is preferable that the viscosity continuously changes in a viscosity adjustment region AD having a width of 2 μm or more, more preferably 3 μm or more, including the boundary between the core 110 and the cladding 120 (point PO at which an absolute value of a refractive index gradient is maximized). When the viscosity adjustment region is defined on the cross section of the optical fiber 100a orthogonal to the central axis AX, the viscosity adjustment region AD is an annular region having an inner peripheral portion and an outer peripheral portion arranged to sandwich the boundary between the core 110 and the cladding 120 in a state of being separated by a distance of 2 μm or more, preferably 3 μm or more. Accordingly, the distance between the inner peripheral portion and the outer peripheral portion corresponds to a width of the viscosity adjustment region AD defined along a radial direction.

In order to control the viscosity change near the boundary between the core 110 and the cladding 120 to be gentle as illustrated in FIG. 4, Cl is preferably added to the core 110 together with Br. At least one or more additives (in addition to Br, F, Cl, and the like as necessary) added to the core 110 and the cladding 120 of the optical fiber 100a according to the first embodiment are desirably added, for example, in soot deposition in a manufacturing process of the optical fiber preform 10 illustrated in FIG. 1.

In addition to the above-described compressive stress and gentle shape change of the viscosity distribution, an average value of a Cl concentration in the core 110 is preferably 100 ppm or more. Cl is contained, and thus, an increase in transmission loss due to glass defects is further suppressed. More preferably, the average value of the Cl concentration in the core 110 is 200 ppm or more. A 75% percentile value of the Cl concentration in the core 110 is preferably 200 ppm or more. In this case, an increase in transmission loss due to glass defects is further suppressed.

### Second Embodiment

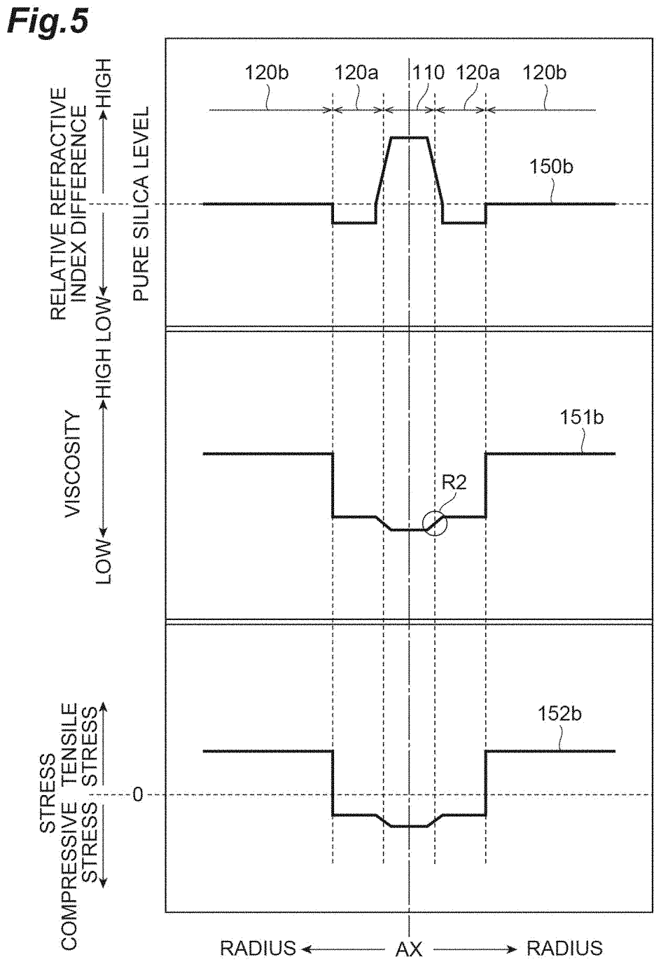

A type-B optical fiber illustrated in a middle part of FIG. 2 is the optical fiber 100b according to the second embodiment of the present disclosure. FIG. 5 illustrates a refractive index profile 150b, a viscosity distribution 151b, and a stress distribution 152b indicated along a common straight line orthogonal to a central axis AX of the optical fiber 100b. A distribution shape of a region R2 in the viscosity distribution 151b shown in FIG. 5 is substantially similar to the distribution shape shown in FIG. 4.

As illustrated in the middle part of FIG. 2, the type-B optical fiber 100b according to the second embodiment includes a core 110 extending along the central axis AX of the optical fiber 100b, a first cladding 120a surrounding the core 110, a second cladding 120b surrounding the first cladding 120a, a primary coating 210 surrounding the second cladding 120b, and a secondary coating 220 surrounding the primary coating 210. The first cladding 120a and the second cladding 120b constitute a cladding 120.

Similarly to the optical fiber 100a according to the first embodiment, the core 110 is comprised of silica glass (SiO₂) containing bromine (Br). In the core 110, a Br concentration is 0.8 wt % or more and 2.6 wt % or less, preferably 1.6 wt % or more and 2.6 wt % or less. A maximum relative refractive index difference of the core 110 is 0.1% or more and 0.3% or less, preferably 0.2% or more and 0.3% or less. The first cladding 120a is comprised of silica glass containing a trace amount of fluorine (F) of 1000 ppm or more and 3000 ppm or less. The second cladding 120b is comprised of pure silica glass or silica glass containing F having a concentration lower than an F concentration of the first cladding 120a. FIG. 5 illustrates a simplified refractive index profile 150b of the optical fiber 100b according to the second embodiment. Here, a profile shape in an outer region of the core 110 is given by the above Equation (1), but in the refractive index profile 150b, the profile shape of the core 110 is shown as a schematic shape.

In the second embodiment, a diameter of the core 110 is 6 μm or more and 12 μm or less. With this configuration, the optical fiber 100b according to the second embodiment has one or more guided modes in a 1550-nm wavelength band that is a lowest loss wavelength band of silica glass (a set of two polarization modes is defined as one guided mode). An effective area of a fundamental mode at a wavelength of 1550 nm is preferably 60 μm2 or more and 160 μm2 or less. An outer diameter of the cladding 120 including the first cladding 120a and the second cladding 120b (substantially an outer diameter of the second cladding 120b) is 125±1 μm. An outer diameter of the entire coating including the primary coating 210 and the secondary coating 220 (substantially an outer diameter of the secondary coating 220) is 245±5 μm, more preferably 200±5 μm.

Subsequently, a median value of the viscosity of each of the core 110 and the first cladding 120a is lower than a maximum value of the viscosity of the second cladding 120b due to a concentration difference between the additives described above. More preferably, the median value of the viscosity of each of the core 110 and the first cladding 120a is lower than a 75% percentile value of the viscosity of the second cladding 120b. Even more preferably, the median value of the viscosity of each of the core 110 and the first cladding 120a is lower than the median value of the viscosity of the second cladding 120b. Due to such a viscosity difference between the portions, tension applied at the time of manufacturing the optical fiber 100b, particularly at the time of drawing the preform is supported by the second cladding 120b, and as a result, tensile stress remains in the second cladding 120b of the optical fiber 100b after drawing, and compressive stress remains in the core 110 and the first cladding 120a. FIG. 5 illustrates a simplified viscosity distribution 151b and a simplified stress distribution 152b of the optical fiber 100b according to the second embodiment in addition to the refractive index profile 150b. Horizontal axes of the refractive index profile 150b, the viscosity distribution 151b, and the stress distribution 152b illustrated in FIG. 5 are illustrated such that positions on a cross section orthogonal to the central axis AX of the optical fiber 100b (positions on a straight line passing through the central axis AX) coincide with each other.

The compressive stress itself depends not only on the viscosity difference between the portions but also on drawing conditions such as tension at the time of drawing the preform. However, in order to suppress an increase in transmission loss, an absolute value of the compressive stress of the core 110 (an absolute value of an average value of stresses remaining in the core 110) is preferably 15 MPa or more, and more preferably 30 MPa or more. Even more preferably, the absolute value of the compressive stress of the core 110 is preferably 30 MPa or more as the absolute value of the 75% percentile value of the stress remaining in each of the core 110 and the first cladding 120a. When the tensile stress remains in the glass, an increase in transmission loss due to glass defects is likely to occur. However, as described above, when the remaining stress of the core 110 and the first cladding 120a is compressive stress in which an absolute value of an average value or an absolute value of the 75% percentile value is sufficiently large, an increase in transmission loss due to local tensile stress is effectively suppressed.

Similarly to the optical fiber 100a according to the first embodiment described above, in the optical fiber 100b according to the second embodiment, the viscosity is different between the core 110 and the first cladding 120a, but a spatial change is preferably continuous and gentle. When the viscosity difference is steep between the core 110 and the first cladding 120a, a large variation in structure and remaining stress occurs at a boundary between the core 110 and the first cladding 120a due to an unintended variation in temperature and tension during drawing. This may cause an increase in transmission loss. Accordingly, a spatial change in viscosity is gentle at the boundary between the core 110 and the first cladding 120a, and thus, an increase in transmission loss is suppressed. A distribution shape of a region R2 of the viscosity distribution 151b is substantially similar to the shape shown in FIG. 4. That is, in the optical fiber 100b according to the second embodiment, it is preferable that the viscosity continuously changes in a viscosity adjustment region AD (annular region) having a width of 2 μm or more, more preferably 3 μm or more, including the boundary between the core 110 and the first cladding 120a (point PO at which an absolute value of a refractive index gradient is maximized).

Similarly to the first embodiment described above, in order to control the viscosity change near the boundary between the core 110 and the first cladding 120a to be gentle, Cl is preferably added to the core 110 together with Br. At least one or more additives (in addition to Br, F, Cl, and the like as necessary) added to the core 110 and the first cladding 120a of the optical fiber 100b according to the second embodiment are desirably added, for example, in soot deposition in a manufacturing process of the optical fiber preform 10 illustrated in FIG. 1.

In addition to the above-described compressive stress and gentle shape change of the viscosity distribution, an average value of a Cl concentration in the core 110 is preferably 100 ppm or more. Cl is contained, and thus, an increase in transmission loss due to glass defects is further suppressed. More preferably, the average value of the Cl concentration in the core 110 is 200 ppm or more. A 75% percentile value of the Cl concentration in the core 110 is preferably 200 ppm or more. In this case, an increase in transmission loss due to glass defects is further suppressed.

As described above, in the optical fiber 100b according to the second embodiment, the second cladding 120b supporting linear tensile force is separated from the core 110 as compared with the optical fiber 100a according to the first embodiment described above. With such a structure, in the optical fiber 100b according to the second embodiment, a degree of freedom in selecting a composition of the core 110 and the first cladding 120a is increased. In particular, since a refractive index difference can be formed between the core 110 and the first cladding 120a by reducing the relative refractive index difference of the first cladding 120a by F addition, a required concentration of Br or Cl to be added to the core 110 can be suppressed low. This suppresses a decrease in yield due to foaming in the core 110 caused by the addition of Br or Cl at a high concentration.

### Third Embodiment

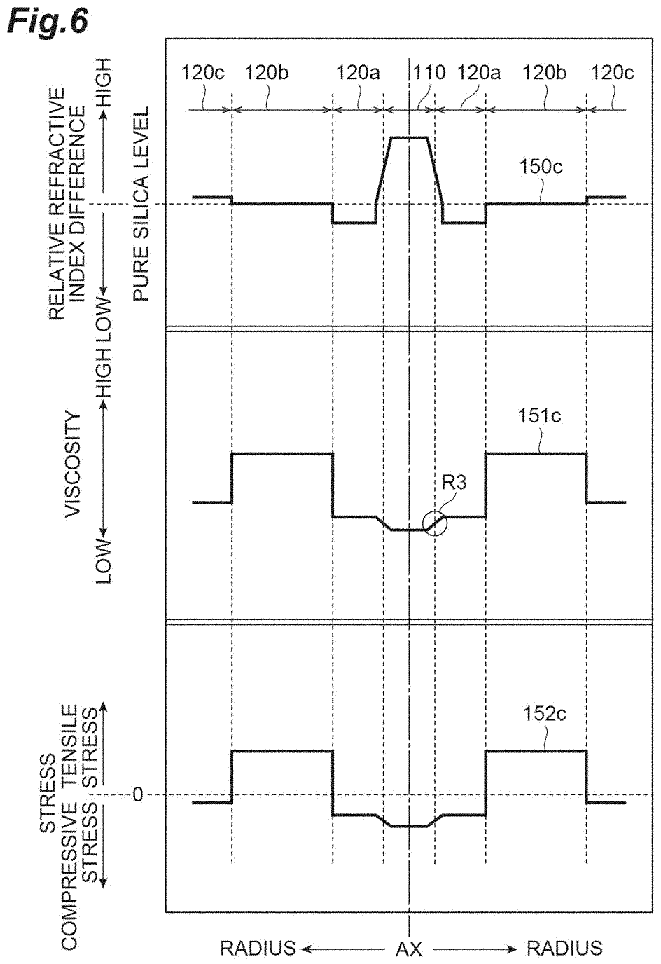

A type-C optical fiber illustrated in a lower part of FIG. 2 is the optical fiber 100c according to the third embodiment of the present disclosure. FIG. 6 illustrates a refractive index profile 150c, a viscosity distribution 151c, and a stress distribution 152c indicated along a common straight line orthogonal to a central axis AX of the optical fiber 100c. A distribution shape of a region R3 in the viscosity distribution 151c shown in FIG. 6 is substantially similar to the distribution shape shown in FIG. 3.

As illustrated in the lower part of FIG. 2, the type-C optical fiber 100c according to the third embodiment includes a core 110 extending along the central axis AX of the optical fiber 100c, a first cladding 120a surrounding the core 110, a second cladding 120b surrounding the first cladding 120a, a third cladding 120c surrounding the second cladding 120b, a primary coating 210 surrounding the third cladding 120c, and a secondary coating 220 surrounding the primary coating 210. The first cladding 120a, the second cladding 120b, and the third cladding 120c constitute a cladding 120.

Similarly to the optical fiber 100a according to the first embodiment and the optical fiber 100b according to the second embodiment, the core 110 is comprised of silica glass (SiO2) containing bromine (Br). In the core 110, a Br concentration is 0.8 wt % or more and 2.6 wt % or less, preferably 1.6 wt % or more and 2.6 wt % or less. A maximum relative refractive index difference of the core 110 is 0.1% or more and 0.3% or less, preferably 0.2% or more and 0.3% or less. The first cladding 120a is comprised of silica glass containing a trace amount of fluorine (F) of 1000 ppm or more and 3000 ppm or less. The second cladding 120b is comprised of pure silica glass or silica glass containing F having a concentration lower than an F concentration of the first cladding 120a. The third cladding 120c contains an F or OH group and has a viscosity lower than a viscosity of the second cladding 120b. FIG. 6 illustrates a simplified refractive index profile 150c of the optical fiber 100c according to the third embodiment. Here, a profile shape in an outer region of the core 110 is given by the above Equation (1), but in the refractive index profile 150c, the profile shape of the core 110 is shown as a schematic shape.

In the third embodiment, a diameter of the core 110 is 6 μm or more and 12 μm or less. With this configuration, the optical fiber 100c according to the third embodiment has one or more guided modes in a 1550-nm wavelength band that is a lowest loss wavelength band of silica glass (a set of two polarization modes is defined as one guided mode). An effective area of a fundamental mode at a wavelength of 1550 nm is preferably 60 μm2 or more and 160 μm2 or less. An outer diameter of the cladding 120 including the first cladding 120a, the second cladding 120b, and the third cladding 120c (actually, an outer diameter of the third cladding 120c) is 125±1 μm. An outer diameter of the entire coating including the primary coating 210 and the secondary coating 220 (substantially an outer diameter of the secondary coating 220) is 245±5 μm, more preferably 200±5 μm.

Subsequently, a median value of the viscosity of each of the core 110, the first cladding 120a, and the third cladding 120c is lower than a maximum value of the viscosity of the second cladding 120b due to a concentration difference between the additives described above. More preferably, the median value of the viscosity of each of the core 110, the first cladding 120a, and the third cladding 120c is lower than a 75% percentile value of the viscosity of the second cladding 120b. Even more preferably, the median value of the viscosity of each of the core 110, the first cladding 120a, and the third cladding 120c is lower than the median value of the viscosity of the second cladding 120b. Due to such a viscosity difference between the portions, tension applied at the time of manufacturing the optical fiber 100c, particularly at the time of drawing the preform is supported by the second cladding 120b, and as a result, tensile stress remains in the second cladding 120b of the optical fiber 100c after drawing, and compressive stress remains in each of the core 110, the first cladding 120a, and the third cladding 120c. FIG. 6 illustrates a simplified viscosity distribution 151c and a simplified stress distribution 152c of the optical fiber 100c according to the third embodiment in addition to the refractive index profile 150c. Horizontal axes of the refractive index profile 150c, the viscosity distribution 151c, and the stress distribution 152c illustrated in FIG. 6 are illustrated such that positions on a cross section orthogonal to the central axis AX of the optical fiber 100c (positions on a straight line passing through the central axis AX) coincide with each other.

The compressive stress itself depends not only on the viscosity difference between the portions but also on drawing conditions such as tension at the time of drawing the preform. However, in order to suppress an increase in transmission loss, an absolute value of the compressive stress in each of the core 110, the first cladding 120a, and the third cladding 120c (an absolute value of an average value of the remaining stress in each portion) is preferably 15 MPa or more, and more preferably 30 MPa or more. Even more preferably, the absolute value of the compressive stress in each of the core 110, the first cladding 120a, and the third cladding 120c is preferably 30 MPa or more as the absolute value of the 75% percentile value of the stress remaining in each portion. When the tensile tension remains in the glass, an increase in transmission loss due to glass defects is likely to occur. However, as described above, since the average value or 75% percentile value of the remaining stress remaining in each of the core 110, the first cladding 120a, and the third cladding 120c is a sufficiently large compressive stress, an increase in transmission loss due to local tensile tension is suppressed.

Similarly to the optical fiber 100a according to the first embodiment and the optical fiber 100b according to the second embodiment described above, in the optical fiber 100c according to the third embodiment, the viscosity is different between the core 110 and the first cladding 120a, but a spatial change is preferably continuous and gentle. When the viscosity difference is steep between the core 110 and the first cladding 120a, a large variation in structure and remaining stress occurs at a boundary between the core 110 and the first cladding 120a due to an unintended variation in temperature and tension during drawing. This may cause an increase in transmission loss. Accordingly, a spatial change in viscosity is gentle at the boundary between the core 110 and the first cladding 120a, and thus, an increase in transmission loss is suppressed. A distribution shape of a region R3 of the viscosity distribution 151c is substantially similar to the shape shown in FIG. 4. That is, in the optical fiber 100c according to the third embodiment, it is preferable that the viscosity continuously changes in a viscosity adjustment region AD (annular region) having a width of 2 μm or more, more preferably 3 μm or more, including the boundary between the core 110 and the first cladding 120a (point PO at which a refractive index gradient is maximized).

Similarly to the first embodiment and the second embodiment described above, in order to control the viscosity change near the boundary between the core 110 and the first cladding 120a to be gentle, Cl is preferably added to the core 110 together with Br. At least one or more additives (in addition to Br, F, Cl, and the like as necessary) added to the core 110 and the first cladding 120a of the optical fiber 100c according to the third embodiment are desirably added, for example, in soot deposition in a manufacturing process of the optical fiber preform 10 illustrated in FIG. 1.

In addition to the above-described compressive stress and gentle shape change of the viscosity distribution, an average value of a Cl concentration in the core 110 is preferably 100 ppm or more. Cl is contained, and thus, an increase in transmission loss due to glass defects is further suppressed. More preferably, the average value of the Cl concentration in the core 110 is 200 ppm or more. A 75% percentile value of the Cl concentration in the core 110 is preferably 200 ppm or more. In this case, an increase in transmission loss due to glass defects is further suppressed.

As described above, in the optical fiber 100c according to the third embodiment, the compressive stress remains in the outermost third cladding 120c of a multilayer structure of the cladding 120. As a result, even though a mechanical scratch is given to an outer surface of the cladding 120, a progress speed of the scratch can be suppressed to be low. As a result, a high fatigue coefficient is obtained in the optical fiber 100c, and long-term reliability is improved. Preferably, a dynamic fatigue coefficient is 20 or more.

### Fourth Embodiment

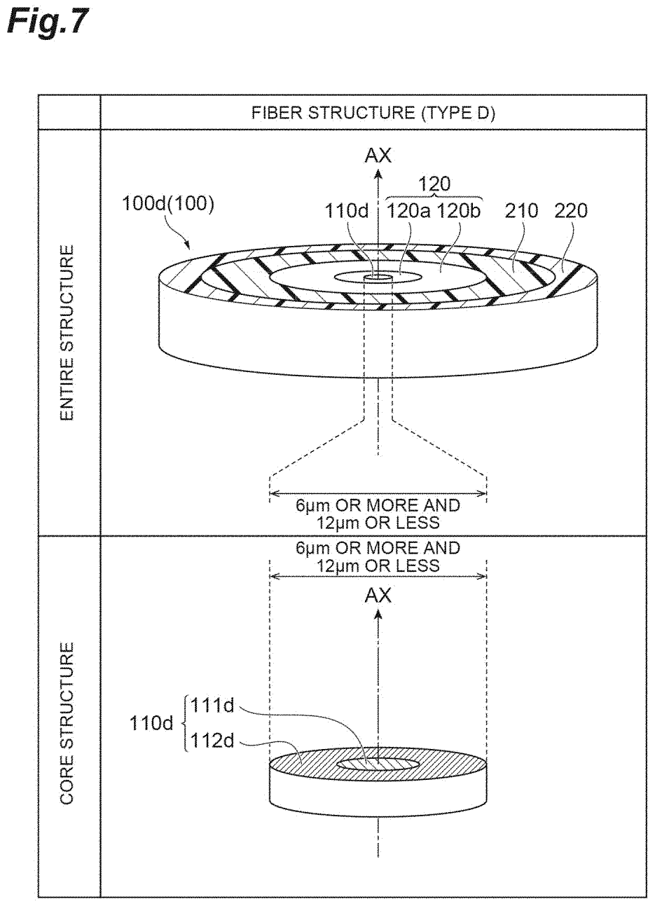

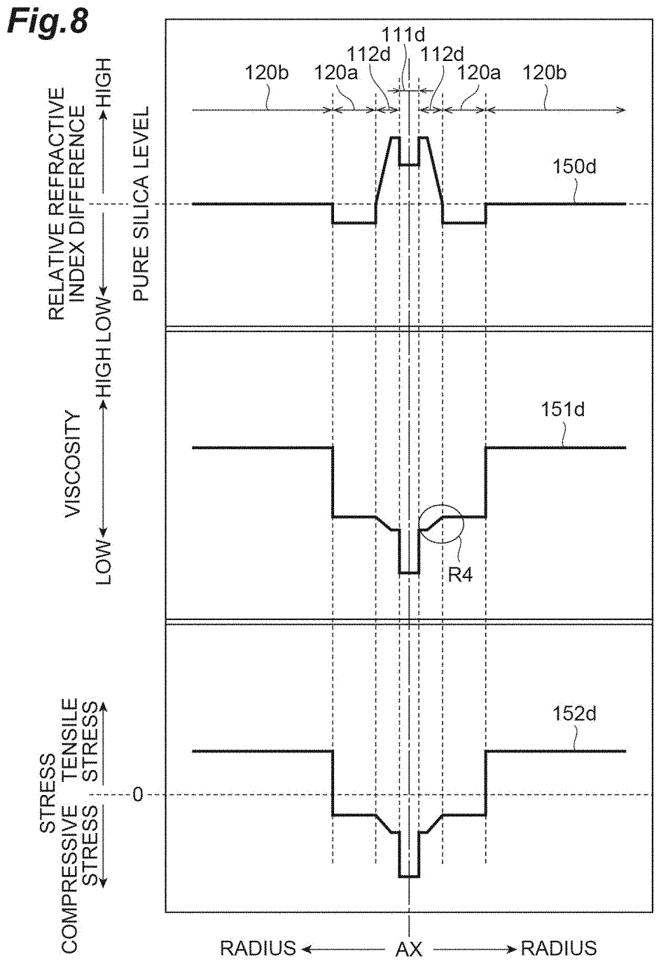

A type-D optical fiber illustrated in FIG. 7 is an optical fiber 100d according to the fourth embodiment of the present disclosure. FIG. 8 illustrates a refractive index profile 150d, a viscosity distribution 151d, and a stress distribution 152d indicated along a common straight line orthogonal to a central axis AX of the optical fiber 100d. A distribution shape of a region R4 in the viscosity distribution 151d shown in FIG. 8 is substantially similar to the distribution shape shown in FIG. 3.

As illustrated in FIG. 7, the type-D optical fiber 100d according to the fourth embodiment includes a core 110d extending along the central axis AX of the optical fiber 100d, a first cladding 120a surrounding the core 110d, a second cladding 120b surrounding the first cladding 120a, a primary coating 210 surrounding the second cladding 120b, and a secondary coating 220 surrounding the primary coating 210. The first cladding 120a and the second cladding 120b constitute a cladding 120.

The core 110d includes a first core hid extending along the central axis AX and a second core 112d surrounding the first core 111d and extending along the central axis AX. The first core 111d is comprised of silica glass to which an alkali element is added. The alkali element is one or more of sodium (Na), potassium (K), rubidium (Rb), or cesium (Cs). Since an atomic concentration of the alkali element in the first core 111d is 1 ppm or more and 100 ppm or less with respect to the number of silicon (Si) atoms of silica glass, an increase in transmission loss due to addition can be suppressed, and simultaneously, the viscosity of the first core 111d can be effectively reduced. In addition to the alkali element, chlorine (Cl) and fluorine (F) may be co-added to the first core 111d, and thus, the viscosity can be further effectively reduced. Similarly to the optical fiber 100a according to the first embodiment and the optical fiber 100b according to the second embodiment, the second core 112d is comprised of silica glass (SiO₂) containing bromine (Br). In the second core 112d, a Br concentration is 0.8 wt % or more and 2.6 wt % or less, preferably 1.6 wt % or more and 2.6 wt % or less. A maximum relative refractive index difference of the core 110d is 0.1% or more and 0.3% or less, preferably 0.2% or more and 0.3% or less. The first cladding 120a is comprised of silica glass containing a trace amount of fluorine (F) of 1000 ppm or more and 3000 ppm or less. The second cladding 120b is comprised of pure silica glass or silica glass containing F having a concentration lower than an F concentration of the first cladding 120a. FIG. 8 illustrates a simplified refractive index profile 150d of the optical fiber 100d according to the fourth embodiment. Here, a profile shape in an outer region of the core 110d is given by the above Equation (1), but in the refractive index profile 150d, the profile shape of the core 110d is shown as a schematic shape.

In the fourth embodiment, a diameter of the core 110d is 6 μm or more and 12 μm or less. With this configuration, the optical fiber 100d according to the fourth embodiment has one or more guided modes in a 1550-nm wavelength band that is a lowest loss wavelength band of silica glass (a set of two polarization modes is defined as one guided mode). An effective area of a fundamental mode at a wavelength of 1550 nm is preferably 60 μm² or more and 160 μm² or less. An outer diameter of the cladding 120 including the first cladding 120a and the second cladding 120b is 125±1 μm. An outer diameter of the entire coating including the primary coating 210 and the secondary coating 220 (substantially an outer diameter of the secondary coating 220) is 245±5 μm, preferably 200±5 μm.

Subsequently, a median value of the viscosity of each of the first core 111d, the second core 112d, and the first cladding 120a is lower than a maximum value of the viscosity of the second cladding 120b due to a concentration difference between the additives described above. More preferably, the median value of the viscosity of each of the first core 111d, the second core 112d, and the first cladding 120a is lower than a 75% percentile value of the viscosity of the second cladding 120b. Even more preferably, the median value of the viscosity of each of the first core 111d, the second core 112d, and the first cladding 120a is lower than the median value of the viscosity of the second cladding 120b. Due to such a viscosity difference between the portions, tension applied at the time of manufacturing the optical fiber 100d, particularly at the time of drawing the preform is supported by the second cladding 120b, and as a result, tensile stress remains in the second cladding 120b of the optical fiber 100d after drawing, and compressive stress remains in each of the first core hid, the second core 112d, and the first cladding 120a. FIG. 8 illustrates a simplified viscosity distribution 151d and a simplified stress distribution 152d of the optical fiber 100d according to the fourth embodiment in addition to the refractive index profile 150d. Horizontal axes of the refractive index profile 150d, the viscosity distribution 151d, and the stress distribution 152d illustrated in FIG. 8 are illustrated such that positions on a cross section orthogonal to the central axis AX of the optical fiber 100d (positions on a straight line passing through the central axis AX) coincide with each other.

The compressive stress itself depends not only on the viscosity difference between the portions but also on drawing conditions such as tension at the time of drawing the preform. However, in order to suppress an increase in transmission loss, an absolute value of the compressive stress in each of the first core 111d, the second core 112d, and the first cladding 120a (an absolute value of an average value of the remaining stress in each portion) is preferably 15 MPa or more, and more preferably 30 MPa or more. Even more preferably, the absolute value of the compressive stress in each of the first core 111d, the second core 112d, and the first cladding 120a is preferably 30 MPa or more as the absolute value of the 75% percentile value of the stress remaining in each portion. When the tensile tension remains in the glass, an increase in transmission loss due to glass defects is likely to occur. However, as described above, since the average value or 75% percentile value of the remaining stress remaining in each of the first core 111d, the second core 112d, and the first cladding 120a is a sufficiently large compressive stress, an increase in transmission loss due to local tensile tension is suppressed.

Similarly to the optical fiber 100a according to the first embodiment and the optical fiber 100b according to the second embodiment described above, in the optical fiber 100d according to the fourth embodiment, the viscosity is different between the second core 112d and the first cladding 120a, but a spatial change is preferably continuous and gentle. When the viscosity difference is steep between the second core 112d and the first cladding 120a having a large refractive index difference therebetween, a large variation in structure and remaining stress occurs at a boundary between the second core 112d and the first cladding 120a due to an unintended variation in temperature and tension during drawing. This may cause an increase in transmission loss. Accordingly, a spatial change in viscosity is gentle at the boundary between the second core 112d and the first cladding 120a, and thus, an increase in transmission loss is suppressed. A distribution shape of a region R4 of the viscosity distribution 151d is substantially similar to the shape shown in FIG. 4. That is, in the optical fiber 100d according to the fourth embodiment, it is preferable that the viscosity continuously changes in a viscosity adjustment region AD (annular region) having a width of 2 μm or more, more preferably 3 μm or more, including the boundary between the second core 112d and the first cladding 120a (point PO at which a refractive index gradient is maximized).

Similarly to the first embodiment and the second embodiment described above, in order to control the viscosity change near the boundary between the second core 112d and the first cladding 120a to be gentle, Cl is preferably added to the second core 112d together with Br. At least one or more additives (in addition to Br, F, Cl, and the like as necessary) added to the second core 112d and the first cladding 120a of the optical fiber 100d according to the fourth embodiment are desirably added, for example, in soot deposition in a manufacturing process of the optical fiber preform 10 illustrated in FIG. 1.

In addition to the above-described compressive stress and gentle shape change of the viscosity distribution, an average value of a Cl concentration in the core 110 is preferably 100 ppm or more. Cl is contained, and thus, an increase in transmission loss due to glass defects is further suppressed. More preferably, the average value of the Cl concentration in the core 110 is 200 ppm or more. A 75% percentile value of the Cl concentration in the core 110 is preferably 200 ppm or more. In this case, an increase in transmission loss due to glass defects is further suppressed.

As described above, in the optical fiber 100d according to the fourth embodiment, as compared with the optical fibers 100a to 100c according to the first to third embodiments described above, the alkali element is contained in the first core 111d forming a part of the core 110, and thus, the viscosity of the first core can be effectively reduced. Since the alkali element can be diffused into the second core surrounding the first core and further into the first cladding surrounding the second core in the drawing step, the viscosity reduction effect can also be obtained in the second core and the first cladding. As a result, since the compressive stress can be effectively formed in the first core, the second core, and the first cladding regardless of the drawing conditions, it is easy to optimize a drawing speed and linear tensile force from the viewpoint of productivity, and as a result, the manufacturing cost of the optical fiber can be reduced.

### REFERENCE SIGNS LIST

1 . . . optical fiber manufacturing apparatus
10 . . . optical fiber preform
21, 22 . . . resin coating device
23 . . . drawing furnace
24 . . . heating furnace
25 . . . cooling device
26 . . . die
27 . . . ultraviolet light source
28 . . . roller
29 . . . capstan
30 . . . winder
100, 100a, 100b, 100c, 100d . . . optical fiber
110, 110d . . . core
111d . . . first core
112d . . . second core
120 . . . cladding
120a . . . first cladding
120b . . . second cladding
120c . . . third cladding
210 . . . primary coating
220 . . . secondary coating
AX . . . central axis
150a, 150b, 150c, 150d . . . refractive index profile
151a, 151b, 151c, 151d . . . viscosity distribution
152a, 152b, 152c, 152d . . . stress distribution
AD . . . viscosity adjustment region
AX . . . central axis
R1, R2, R3, R4 . . . region
S . . . arrow (rotation direction)

1: An optical fiber comprising:
a core configured to extend along a central axis, and be comprised of silica glass to which bromine is added; and
a cladding configured to surround the core, have a refractive index lower than a maximum refractive index of the core, and be comprised of silica glass, wherein
the core has compressive stress.

2: The optical fiber according to claim 1, wherein
the cladding includes
a first cladding configured to surround the core, and be comprised of silica glass to which fluorine is added, and
a second cladding configured to surround the first cladding, be comprised of pure silica glass or silica glass to which fluorine having a concentration lower than a fluorine concentration of the first cladding is added, and have tensile stress.

3: The optical fiber according to claim 1, wherein
the cladding includes
a first cladding configured to surround the core, and be comprised of silica glass to which fluorine is added,
a second cladding configured to surround the first cladding, be comprised of pure silica glass or silica glass to which fluorine having a concentration lower than a fluorine concentration of the first cladding is added, and have tensile stress, and
a third cladding configured to surround the second cladding, be comprised of pure silica glass or silica glass to which fluorine having a concentration lower than a fluorine concentration of the first cladding is added, and have compressive stress.

4: The optical fiber according to claim 1, wherein
the core further contains chlorine, and
a viscosity adjustment region defined on a cross section of the optical fiber orthogonal to the central axis has a shape surrounding the central axis in a state of being separated from the central axis, an inner peripheral portion and an outer peripheral portion arranged to sandwich a boundary between the core and the cladding in a state of being separated by a distance 2 μm or more, and a viscosity distribution continuously changing along a radial direction from the central axis toward an outer periphery of the optical fiber.
